(19) United States
(12) Patent Application Publication
(10) Pub. No.: US 2026/0361165 A1
(43) Pub. Date: Nov. 12, 2026

(54) SUPPORTING APPARATUS FOR USE WITH ROTOR AND CORRESPONDING ROTOR, ELECTRIC MOTOR AND GENERATOR

(71) Applicant: ABB SCHWEIZ AG, Baden (CH)

(72) Inventors: Qionghao Zhu, Shanghai (CN); Pei Yan, Shanghai (CN); Weimin Li, Shanghai (CN)

(21) Appl. No.: 19/744,330

(22) Filed: Jul. 16, 2026

Related U.S. Application Data
(63) Continuation of application No. PCT/CN2024/073525, filed on Jan. 22, 2024.

(51) Int. Cl. H02K 1/28; H02K 1/24

(52) U.S. Cl. CPC H02K 1/28; H02K 1/24

(57) ABSTRACT

A supporting apparatus for use with a rotor and a corresponding rotor, a corresponding electric motor and a corresponding generator are disclosed. The supporting apparatus includes a supporting element and a plate. The supporting element includes a base portion having a hole for coupling with a fastener, the fastener being configured to insert into the hole along an inserting direction to contact with a base face of the base portion; and a tapering portion connected to the base portion at a side away from the base face, the tapering portion having gradually decreasing outer dimension in a direction away from the tapering portion The plate is configured to mount to the rotor and includes a recess, wherein a dimension of the recess is configured to match one face of the tapering portion to mount to supporting element.

### FIELD

Example embodiments of the present disclosure generally relate to a field of electric motor or generator, and more particularly, to a supporting apparatus for use with a rotor, a corresponding rotor, a corresponding electric motor and a corresponding generator.

### BACKGROUND

Rotor winding is an important component in an electric motor or a generator. A rotor winding bracket is a structure for fixing the rotor winding. Conventionally, the shape of the rotor winding support will vary according to the type of rotor. Since it is impossible to manufacture a rotor winding support suitable for various rotor types in the existing solution, it is necessary to manufacture various rotor winding supports, which greatly increases the manufacturing cost of the whole electric motor or the generator.

### SUMMARY

In general, example embodiments of the present disclosure provide a supporting apparatus for use with a rotor, a corresponding rotor, a corresponding electric motor and a corresponding generator, which address the existing problems and/or any potential problems.

In a first aspect, there is provided a supporting apparatus for use with a rotor. The supporting apparatus comprises: a supporting element comprising: a base portion having a hole for coupling with a fastener, the fastener being configured to insert into the hole along an inserting direction to contact with a base face of the base portion; and a tapering portion connected to the base portion at a side away from the base face, the tapering portion having gradually decreasing outer dimension in a direction away from the tapering portion; and a plate configured to mount to the rotor and comprising a recess, wherein a dimension of the recess is configured to match one face of the tapering portion to mount to supporting element.

According to example embodiments of the present disclosure, no matter the number of the poles of the rotor, the supporting apparatus is applicable, which greatly reduce the manufacturing cost.

In some example embodiments, the tapering portion comprises a plurality of steps arranged in series, and the plurality of steps have a decreasing length and/or width in a direction away from the tapering portion

In some example embodiments, each step has a mounting surface to couple to the recess of the plate, and wherein the angle between the mounting surface and the base face of the base portion is determined based on the number of the supporting apparatus within the rotor.

In some example embodiments, the tapering portion and the base portion are integrally formed.

In some example embodiments, a width of the plate is no less than the distance between an end point of the supporting element and the respective mounting surface of the base portion such that the end point will not go beyond the plate.

In some example embodiments, a dimension of the recess of the plate is determined based on the number of the supporting apparatus within the rotor.

In some example embodiments, the supporting element of the supporting apparatus is a casting block made of metal.

In some example embodiments, the plate of the supporting apparatus is a made of metal.

In a second aspect, there is provided a rotor. The rotor comprises a plurality of pairs of supporting apparatus of the first aspect, wherein the two supporting apparatus of each pairs of supporting apparatus are coupled to a same fastener.

In a third aspect, there is provided an electric motor. The electric motor comprises a rotor of the second aspect.

In a fourth aspect, there is provided a generator. The generator comprises a rotor of the second aspect.

### BRIEF DESCRIPTION OF THE DRAWINGS

Through the following detailed description with reference to the accompanying drawings, the above and other objectives, features and advantages of the example embodiments disclosed herein will become more comprehensible. In the drawings, several example embodiments disclosed herein will be illustrated in an exemplary and in a non-limiting manner, wherein:

FIG. 1 illustrates a perspective view of the rotor in accordance with an example embodiment of the present disclosure;

FIG. 2 illustrates a perspective view of one pair of supporting apparatus in accordance with an example embodiment of the present disclosure, which is the enlarged view of portion A in FIG. 1;

FIG. 3 illustrates perspective view of the supporting element of the supporting apparatus in accordance with an example embodiment of the present disclosure;

FIG. 4 illustrate perspective views of the plate of the supporting apparatus in accordance with an example embodiment of the present disclosure;

FIGS. 5A-5D illustrate the perspective views of various working status of the supporting apparatus in accordance with an example embodiment of the present disclosure;

FIGS. 6A-6D illustrate the sectional views of various working status of the supporting apparatus in accordance with an example embodiment of the present disclosure; and

FIG. 7 illustrates the relationship between the number of the supporting apparatus within the rotor and the angle between the plate and the base face of the supporting element.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and to help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skill in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to apply such feature, structure, or characteristic in connection with other embodiments whether or not explicitly described.

It should be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As described above, for an existing rotor winding, since it is impossible to manufacture one rotor winding supports suitable for various rotor types, different structures of supporting apparatus, or known as rotor winding bracket, with different poles and shaft height are required. This would cause much inconvenience. For example, since the supporting apparatus is made of aluminum by casting or extrusion process, many casting or extrusion tools have to be prepared to match different poles and shaft height. Unfortunately, this will cost much.

Besides, the minimum order quantity for the supporting apparatus is very big for example several hundreds. Since it is required to prepare different structure with poles and shaft height, once several hundreds of one kind of winding support are purchased, they cannot be used for other poles and shaft height, it makes the factory have too many stocks for the winding support, it also will cause extra cost. Moreover, since the operators have too many different designs for the supporting apparatus, it will make the whole design more complicated.

At least to address the problem existed in the conventional approaches, the present disclosure proposes a structure which is general for all poles and shaft height, which makes one general design which can cover all the application.

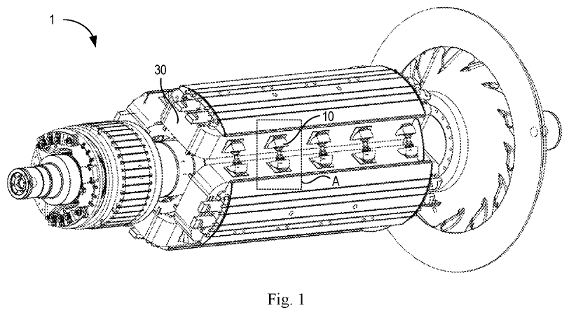

Example embodiments of the present disclosure will be described in more detail hereinafter in accordance with FIGS. 1-7.

FIG. 1 illustrates a perspective view of the rotor 1 in accordance with an example embodiment of the present disclosure. As shown in FIG. 1, the rotor 1 includes a plurality of supporting apparatus 10. The supporting apparatus 10 are used in pairs to support the coils 30 of the rotor 1. The number of the pairs of the supporting apparatus 10, no matter along the axial direction of the rotor 1 or the circumferential direction of the rotor 1, are not limited to the illustrated example, they can be adjusted according to the type of the rotor 1 in actual scenarios.

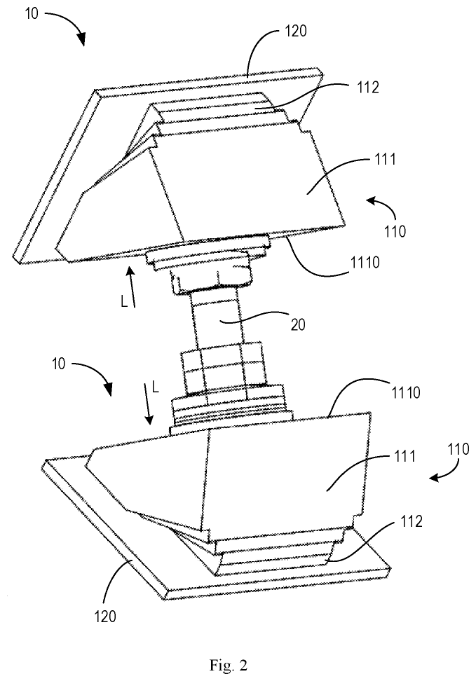

FIG. 2 illustrates a perspective view of one pair of supporting apparatus 10 in accordance with an example embodiment of the present disclosure, which is the enlarged view of portion A in FIG. 1. As shown in FIG. 2, the pair of the supporting apparatus 10 are connected via a fastener 20. The fastener 20 may firmly couple the supporting apparatus 10 to the coil 30 of the rotor 1. The supporting apparatus 10 includes a supporting element 110 and a plate 120.

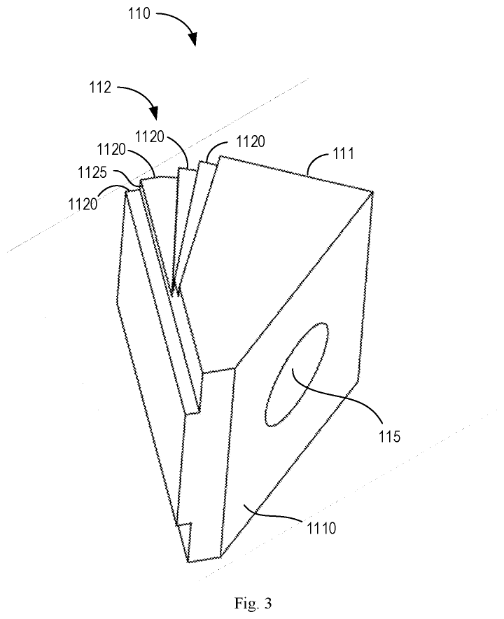

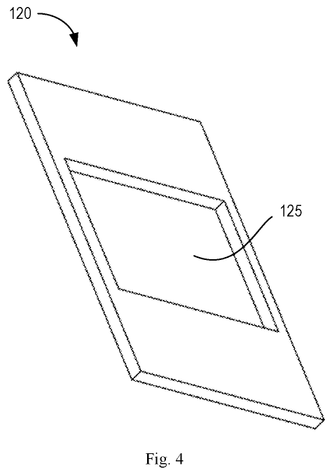

FIGS. 3-4 illustrate perspective views of the supporting element 110 and the plate 120 in accordance with an example embodiment of the present disclosure, respectively.

With reference to FIG. 3, the supporting element 110 includes a base portion 111 and a tapering portion 112. In some example embodiments, the base portion 111 and the tapering portion 112 are integrally formed.

With reference to FIG. 3 and back to FIG. 2, the base portion 111 includes a hole 115 for coupling with the fastener 20. The fastener 20 is configured to insert into the hole 115 along an inserting direction L to contact with a base face 1110 of the base portion 111, so as to couple the pair of the supporting apparatus 10 together.

As shown in FIG. 3, the tapering portion 112 is connected to the base portion 111 at a side away from the base face 1110, and has a gradually decreasing outer dimension in a direction away from the tapering portion 112. In the shown embodiment, the tapering portion 112 comprises a plurality of steps 1120 arranged in series. Owing to the fact that the plurality of steps 1120 have a gradually decreasing outer dimension, each step 1120 will have a mounting surface 1125 near the adjacent step 1120. The mounting surface 1125 may act as a stopping surface to couple to the plate 120, which will be discussed in detail hereinafter.

With reference to FIG. 4, the plate 120 includes a recess 125. The dimension of the recess 125 is designed to match any one of the mounting surface 1125 to couple to any one the step 1120.

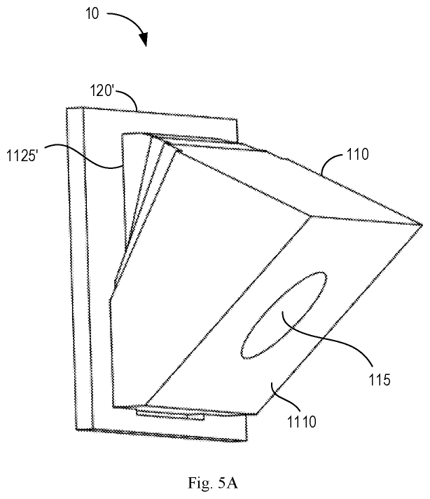

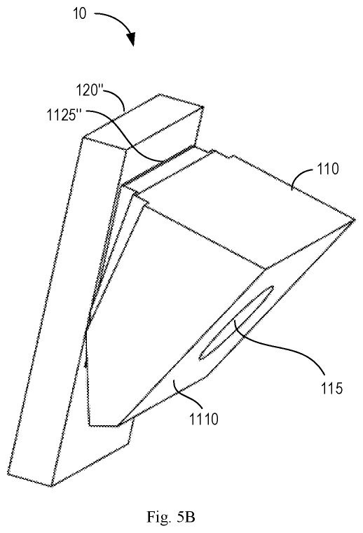

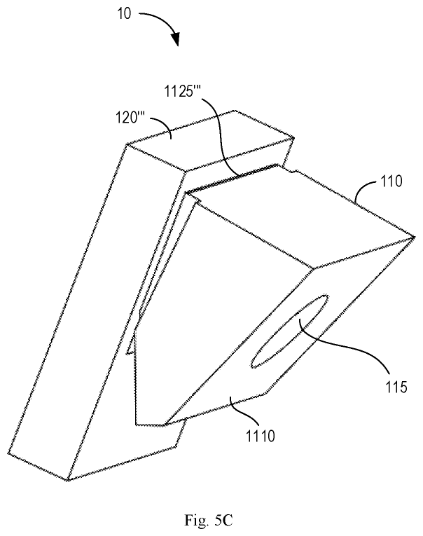

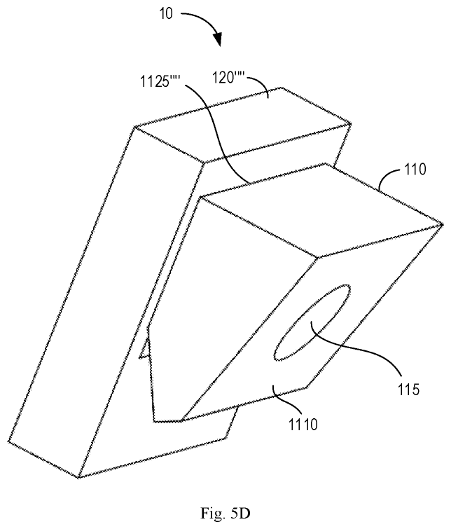

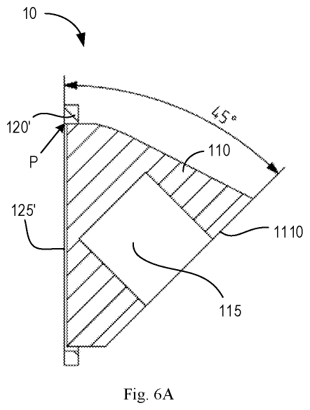

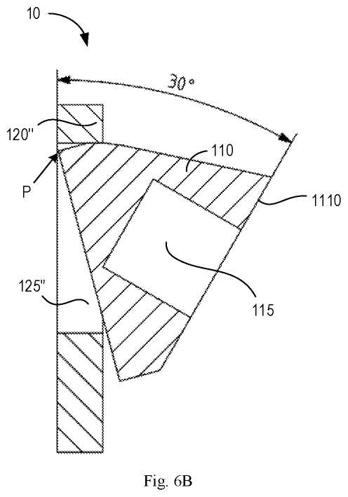

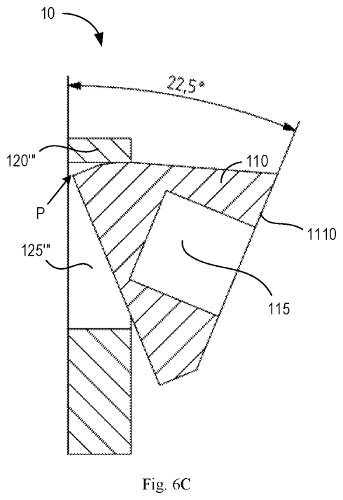

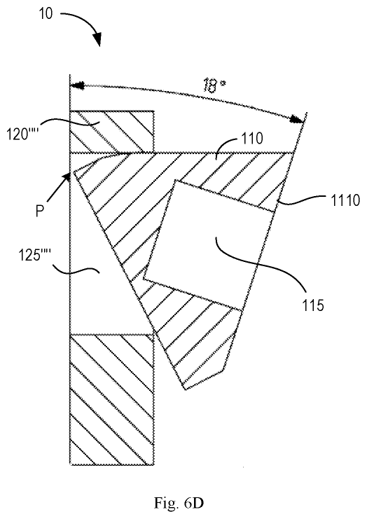

FIGS. 5A-5D illustrate the perspective views of various working status of the supporting apparatus 10 in accordance with an example embodiment of the present disclosure. Correspondingly, FIGS. 6A-6D illustrate the sectional views of various working status of the supporting apparatus 10 in accordance with an example embodiment of the present disclosure.

The supporting element 110 are the same element throughout FIGS. 5A-5D, while the plate 120 are different plate with different dimensions of the recess 125 to achieve different working status. Different working status will generate different angles between the plate 120 and the base face 1110.

For example, with reference to FIG. 5A and the corresponding 6A, which show that the plate 120′ is in 45 degrees with respect to the base face 1110 of the supporting element 110, which may be applicable for the rotor 1 with four poles. As shown in FIG. 5A, the plate 120′ is firmly coupled to the first mounting surface 1125′ of the supporting element 110 which is farthest away from the base face 1110. The recess 125′ of the plate 120′ is dimensioned such that the recess 125′ may be exactly couple to the mounting surface 1125′, rather than other mounting surfaces. In the shown embodiment, since the angle between the mounting surface 1125′ and the base face 1110 is designed to be 45 degrees, the plate 120′ when coupling with the mounting surface 1125′ is 45 degrees with respect to the base face 1110 of the supporting element 110.

With reference to FIG. 5B and the corresponding 6B, which show that the plate 120″ is in 30 degrees with respect to the base face 1110 of the supporting element 110, which may be applicable for the rotor 1 with six poles. Another plate 120″ different from the plate 120′ in FIG. 5A is firmly coupled to the second mounting surface 1125″ of the supporting element 110. The recess 125″ of the plate 120″ is dimensioned such that the recess 125″ may be exactly couple to the mounting surface 1125″, rather than other mounting surfaces. In the shown embodiment, since the angle between the mounting surface 1125″ and the base face 1110 is designed to be 30 degrees, the plate 120″ when coupling with the mounting surface 1125″ is 30 degrees with respect to the base face 1110 of the supporting element 110.

With reference to FIG. 5C and the corresponding 6C, which show that the plate 120′″ is in 22.5 degrees with respect to the base face 1110 of the supporting element 110, which may be applicable for the rotor 1 with eight poles. Another plate 120′″ different from the plate 120′ in FIG. 5A or the plate 120″ in FIG. 5B is firmly coupled to the third mounting surface 1125′″ of the supporting element 110. The recess 125′″ of the plate 120′″ is dimensioned such that the recess 125′″ may be exactly couple to the mounting surface 1125′″, rather than other mounting surfaces. In the shown embodiment, since the angle between the mounting surface 1125′″ and the base face 1110 is designed to be 22.5 degrees, the plate 120′″ when coupling with the mounting surface 1125′″ is 22.5 degrees with respect to the base face 1110 of the supporting element 110.

With reference to FIG. 5D and the corresponding 6D, which show that the plate 120″″ is in 18 degrees with respect to the base face 1110 of the supporting element 110, which may be applicable for the rotor 1 with ten poles. Another plate 120″″ different from the plate 120′ in FIG. 5A, the plate 120″ in FIG. 5B or the plate 120′″ in FIG. 5C is firmly coupled to the second mounting surface 1125″″. The recess 125″″ of the plate 120″ is dimensioned such that the recess 125″″ may be exactly couple to the mounting surface 1125″″, rather than other mounting surfaces. In the shown embodiment, since the angle between the mounting surface 1125″″ and the base face 1110 is designed to be 18 degrees, the plate 120″″ when coupling with the mounting surface 1125″″ is 18 degrees with respect to the base face 1110 of the supporting element 110.

With reference to FIGS. 5A-6D, the thickness of the plate 120′, 120″, 120′″ or 120″″ is greater than the distance between an end point P and the corresponding mounting surface 1125′, 1125″, 1125′″ or 1125″″ such that the end point P will not go beyond the left side of the plate 120′, 120″, 120′″ or 120″″.

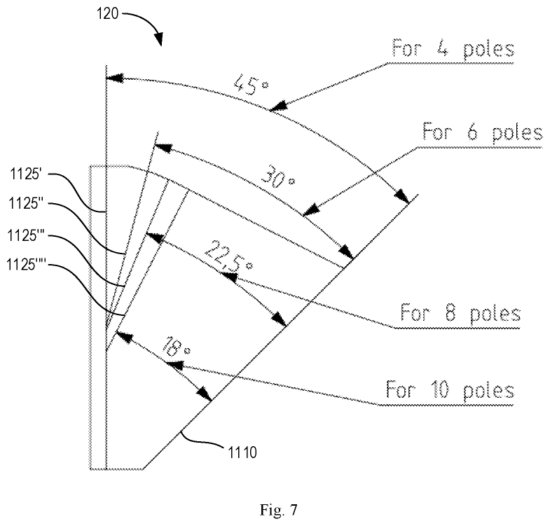

FIG. 7 illustrates the relationship between the number of the supporting apparatus 10 within the rotor 1 and the angle between the plate 120 and the base face 1110 of the supporting element 110. For the rotor 1 having 4 poles, the angle between the plate 120 and the base face 1110 of the supporting element 110 may be designed to be 45 degrees. For the rotor 1 having 6 poles, the angle between the plate 120 and the base face 1110 of the supporting element 110 may be designed to be 30 degrees. For the rotor 1 having 8 poles, the angle between the plate 120 and the base face 1110 of the supporting element 110 may be designed to be 22.5 degrees. For the rotor 1 having 10 poles, the angle between the plate 120 and the base face 1110 of the supporting element 110 may be designed to be 18 degrees. In a word, the angle between the corresponding mounting surface 1125 and the base face 1110 of the base portion 111 is determined based on the number of the supporting apparatus 10 within the rotor 1. The angle between the corresponding mounting surface 1125 and the base face 1110 of the base portion 111 times the number of the supporting apparatus 10 within the rotor 1 may equal to 360, a full angle around a circle.

With reference back to FIGS. 5A-6D, the width of the respective plate 120′, 120″, 120′″ or 120″″ and the dimension of the respective recess 125′, 125″, 125′″, 125″″ of the respective plate 120′, 120″, 120′″ or 120″″ are determined according to the angle between the respective mounting surface 1125′, 1125″, 1125′″, 1125″″ and the base face 1110 of the base portion 111, which is ultimately adjusted based on the number of the supporting apparatus 10 within the rotor 1.

Throughout FIGS. 5A-6D, four different angles are shown, with every different mounting surfaces 1125′, 1125″, 1125′″, 1125″″ match with different plates 120′, 120″, 120′″ or 120″″. When the number of the pole changes, a corresponding mounting surface with different angles may be used. When the height of the fastener 20 changes, a corresponding plate may be used accordingly for adjustment.

In some example embodiments, the supporting element 110 of the supporting apparatus 10 may be a casting block made of metal. In some further embodiments, the metal may be aluminum. The supporting element 110 made of aluminum is good for heat dissipation. It is to be understood that this is just a few examples, and the specific materials of the supporting element 110 are not limited to embodiments of the present disclosure. The supporting element 110 may also be made of other material according to the various need of the users.

In some example embodiments, the plate 120 of the supporting apparatus 10 may be a made of metal. In some further embodiments, the metal may be aluminum. The plate 120 made of aluminum is good for heat dissipation. It is to be understood that this is just a few examples, and the specific materials of the plate 120 are not limited to embodiments of the present disclosure. The plate 120 may also be made of other material according to the various need of the users.

In a second aspect, there is provided a rotor 1. The rotor 1 includes a plurality of pairs of supporting apparatus 10. As shown in FIG. 1, the two supporting apparatus 10 of each pairs of supporting apparatus 10 are coupled to a same fastener 20.

Compared to the existing design of supporting apparatus, according to the example embodiments of the present disclosure, the user of the rotor 1 only need one supporting apparatus 10 for all applications, different poles, different height of the fastener 20, different structure of the rotor 1. For the supporting apparatus 10, when being use with different type of rotor 1, there is no need to change the supporting element 110 and only the plate 120 is required to be changed. Since the plate 120 is much easier and cheaper to manufacture, the design according to the present disclosure will save much for manufacturing cost.

Besides, since the supporting apparatus 10 according to the present disclosure is applicable for a variety of designs, the minimum order quantity will not be an issue anymore, the users have this general design for all products, so the SCM can have a big purchasing quantity (will have much lower price), and they can be used for all products that need supporting apparatus and will solve the factory stock issue. Moreover, the design for supporting apparatus will be uniformed in the platform, and the platform will be much simplified.

It is to be understood that the number of the supporting apparatus 10 within the rotor 1 illustrated in above FIGS. 5A-6D are only for illustration without suggesting any limitations as to the scope of the subject matter described here. It is also to be understood that the specific angles between the plate 120 mounting on the respective mounting surface 1125 and the base face 1110 of the base portion 111 are just a few examples, other values are also possible according to the specific scenarios and the actual needs of the user.

It could be understood that the above shape of the supporting apparatus 10 is merely example without suggesting any limitation as to the scope of the present disclosure, the supporting apparatus 10 may take different shape than the step-like shape. For example, the tapering portion 112 of the supporting element 110 may take an egg-like shape with a gradually decreasing outer dimension in a direction away from the tapering portion. Since a section taken on the egg-like tapering portion 112 is elliptic, the recess 125 of the plate 120 may be an elliptic shape to match the section of the egg-like tapering portion 112 of the supporting element 110 correspondingly. By using the plate 120 with different dimensions of the recess 125, it may be firmly coupled to the supporting element 110 to achieve a variety of angles between the plate 120 and the base face 1110 of the base portion 111.

In a third aspect, there is provided an electric motor. The electric motor comprises the rotor 1 described above.

In a fourth aspect, there is provided a generator. The generator comprises the rotor 1 described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A supporting apparatus for use with a rotor, comprising:
a supporting element comprising:
a base portion having a hole for coupling with a fastener, the fastener being configured to insert into the hole along an inserting direction to contact with a base face of the base portion; and
a tapering portion connected to the base portion at a side away from the base face, the tapering portion having gradually decreasing outer dimension in a direction away from the tapering portion; and
a plate configured to mount to the rotor and comprising a recess, wherein a dimension of the recess is configured to match one face of the tapering portion to mount to supporting element.

2. The supporting apparatus of claim 1, wherein the tapering portion comprises a plurality of steps arranged in series, and the plurality of steps have a decreasing length and/or width in a direction away from the tapering portion.

3. The supporting apparatus of claim 2, wherein each step has a mounting surface to couple to the recess of the plate and wherein the angle between the mounting surface and the base face of the base portion is determined based on the number of the supporting apparatus within the rotor.

4. The supporting apparatus of claim 1, wherein the tapering portion and the base portion are integrally formed.

5. The supporting apparatus of claim 1, wherein a width of the plate is no less than the distance between an end point of the supporting element and the respective mounting surface of the base portion such that the end point will not go beyond the plate.

6. The supporting apparatus of claim 1, wherein a dimension of the recess of the plate is determined based on the number of the supporting apparatus within the rotor.

7. The supporting apparatus of claim 1, wherein the supporting element of the supporting apparatus is a casting block made of metal.

8. The supporting apparatus of claim 1, wherein the plate of the supporting apparatus is a made of metal.

9. A rotor, comprising a plurality of pairs of the supporting apparatus of claim 1, wherein the two supporting apparatuses. of each of the plurality of pairs of supporting apparatus are coupled to a same fastener

10. An electric motor comprising the rotor of claim 9.

11. A generator comprising the rotor of claim 9.
